(19) United States
(12) Patent Application Publication
(10) Pub. No.: US 2018/0316572 A1
(43) Pub. Date: Nov. 1, 2018

(54) CLOUD LIFECYCLE MANAGMENT

(71) Applicant: HEWLETT PACKARD ENTERPRISE DEVELOPMENT LP, Houston, TX (US)

(72) Inventors: Chandra Kamalakantha, Plano, TX (US); Parag Doshi, Marietta, GA (US); Steven Marney, Lake Orion, MI (US)

(21) Appl. No.: 15/770,338

(22) PCT Filed: Oct. 30, 2015
(86) PCT No.: PCT/US2015/058512

§ 371 Date: Apr. 23, 2018

(51) Int. Cl. H04L 12/24; H04L 29/08

(52) U.S. Cl. CPC H04L 41/16; H04L 67/2809

(57) ABSTRACT

Lifecycle management in a cloud environment is disclosed. The lifecycle management includes accessing lifecycle actions of an orchestration from a service registry. The orchestration is executed in the cloud environment. Lifecycle actions not available in the service registry are non-deterministically injected into the orchestration.

### BACKGROUND

Cloud computing is a model of service delivery for enabling convenient, on-demand network access to a shared pool of configurable computing resources that can be rapidly provisioned and released with token management effort or interaction with a provider of the service. Cloud computing allows a consumer to obtain processing resources, such as networks, network bandwidth, servers, processing memory, storage, applications, virtual machines, and services as a service on an elastic and sometimes impermanent basis. Several vendors are currently offering cloud services. Cloud services include infrastructure as a service, platform as a service, storage as a service, software as a service, business process as a service, and other services. These services use vendor-specific service request, access, and consumption models.

### BRIEF DESCRIPTION OF THE DRAWINGS

FIG. 1 is a schematic diagram illustrating an example cloud computing environment.

FIG. 2 is a block diagram illustrating a method for use with the system of FIG. 1.

FIG. 3 is a block diagram illustrating an example system in the cloud computing environment of FIG. 1.

FIG. 4 is a block diagram illustrating an example feature of the system of FIG. 3.

FIG. 5 is a schematic diagram illustrating an example computing device that can be used to implement the system of FIG. 2 and perform the method of FIG. 4.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Cloud providers can use cloud service management, or enterprise management, tools to automate the management of cloud-based Information Technology (IT)-as-a-service from order, to provision, to retirement. Some cloud systems, such as hybrid clouds and other clouds, provide particular challenges for cloud providers and cloud service management tools. Cloud management tools applied to such cloud systems often encounter unavailable resources in such cloud systems or variable resources depending on the cloud system. For example, a selected cloud environment in a hybrid cloud system may not include a disaster recovery system or backup and restore service, or implementations of service offerings could vary depending on the environment selected. Traditional cloud management tools typically include procedural or deterministic programming constructs to sequence and declare the automation or lifecycle steps to be performed. Variability in the target environments is accounted for with long if-then-else statements that provide an arduous path to a predetermined solution. Such statements may be difficult for IT professionals to construct because they may involve complex logic. Such statements may also be limiting because the logic must be revisited if new resources or environments are introduced.

Examples of systems, methods, and computer readable media for performing the methods that apply deterministic and nondeterministic constructs to manage cloud systems that can include a variability of resources such as hybrid cloud systems and other cloud systems are disclosed. In one example, an orchestration design in a cloud automation process can be sequential and declarative, but resource changes or other variables allow for event-based architecture to configure a runtime that is not accounted for in the solution. Examples of these systems and methods are described in more detail below.

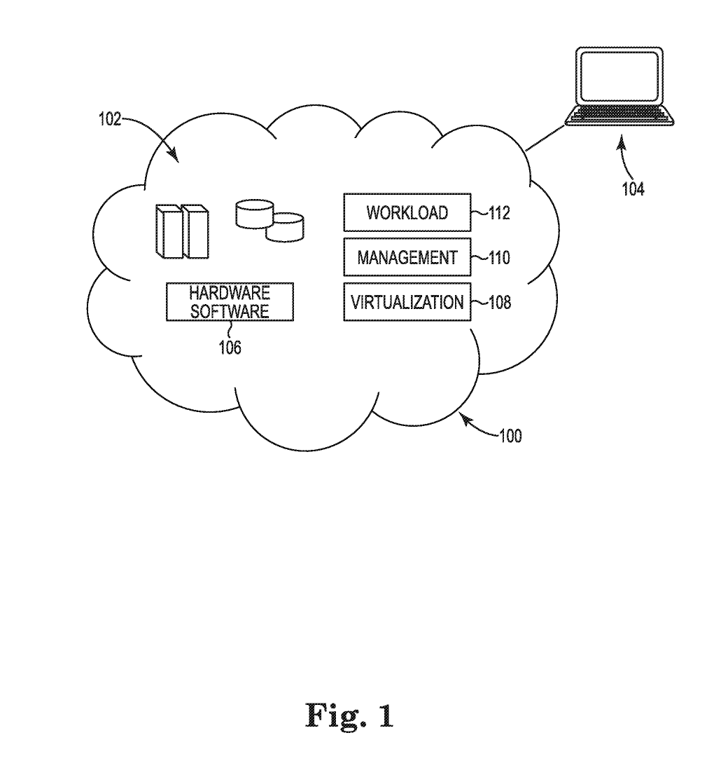

FIG. 1 illustrates an example cloud computing environment 100 suitable for use with a hybrid cloud management system. Cloud computing environment 100 includes one or more interconnected cloud computing nodes 102 configured to communicate with local computing devices 104 such as personal computers, mobile devices, embedded systems, or other computing devices used by cloud consumers. Cloud computing environment 100 includes features such as statelessness, low coupling, modularity, and semantic interoperability. Cloud computing nodes 102 can be configured as computing devices including a processor, memory, storage, communication components, and software in the form of program modules stored in the memory. Cloud computing nodes 102 may be grouped physically or virtually in one or more networks or in one or more cloud deployment models. The cloud computing environment 100 offers services such as infrastructure, platforms, software, and business processes.

Cloud computing environment 100 can include a set of abstraction layers such as a hardware and software layer 106, virtualization layer 108, management layer 110, and workload layer 112. The hardware and software layer 106 includes hardware and software components such as servers, storage devices, networking and networking components, network application software, database software, and related software. The virtualization layer 108 provides virtualization entities such as virtual servers, storage, networks, and applications. The management layer 110 provides entities such as resource provisioning, metering, and billing services for tracking and invoicing use, user portals for allowing cloud consumers and others access to the cloud computing environment 100, security, and service level management. Workload layer 112 provides functions such as mapping and navigation, software development and lifecycle management, data processing, and transaction processing. The components, layers, and other features of the cloud computing environment 100 are intended to be illustrative, and other example configurations are contemplated.

Cloud computing environment 100 is generally deployed in one or more recognized models. A private cloud deployment model includes an infrastructure operated solely for an organization whether it is managed internally or by a third-party and whether it is hosted on premises of the organization or some remote off-premises location. An example of a private cloud includes a self-run data center. A public cloud deployment model includes an infrastructure made available to the general public or a large section of the public such as an industry group and run by an organization offering cloud services. A community cloud is shared by several organizations and supports a particular community of organizations with common concerns such as jurisdiction, compliance, or security. Deployment models generally include similar cloud architectures, but may include specific features addressing specific considerations such as security in shared cloud models.

A hybrid cloud is a deployment model that includes two or more clouds, such as private clouds, public clouds, and community clouds or combinations of two or more of each deployment model, that remain unique entities. Hybrid clouds include technology to bind together the two or more clouds, and in some examples permit data and application portability across clouds, such as cloud bursting for load balancing, and service interoperability.

Cloud computing providers generally offer services for the cloud computing environment as a service model including infrastructure as a service, platform as a service, software as a service, and other services. Infrastructure as a service providers offer the capability to provision processing, storage, networks, and other basic computing resources. The consumer generally does not manage the underlying cloud infrastructure, but generally retains control over the computing platform and applications that run on the platform. Platform as a service providers offer operating systems, execution runtimes, databases, and webservers, i.e., computing platforms. The consumer generally does not have control over the underlying infrastructure or computing platform, but can manage applications running on the platform. Software as a service providers offer software applications as a subscription service that are generally accessible from web browsers or other thin-client interfaces, and consumers do not load the applications on the local computing devices.

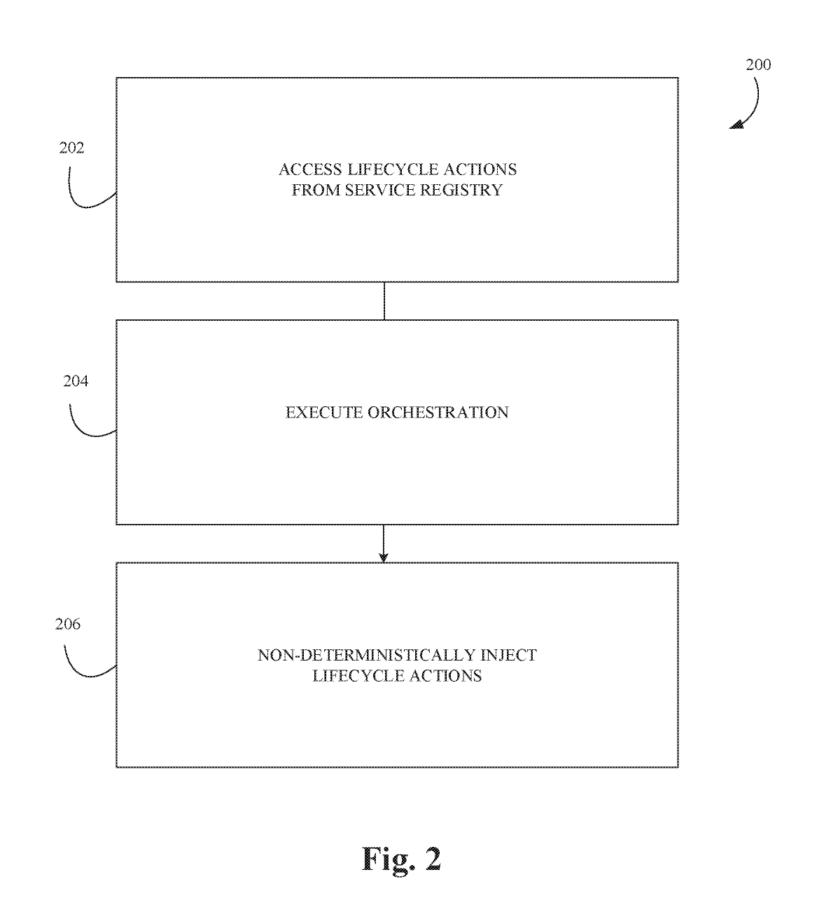

FIG. 2 illustrates an example method 200 of managing a cloud environment, such as cloud environment 100. Method 200 includes accessing lifecycle actions of an orchestration from a service registry at 202. The orchestration is executed in the cloud environment at 204. Lifecycle actions not available to be accessed from the service registry are non-deterministically created and injected into the orchestration at 206. Injecting can include non-deterministically creating. In the example method, an orchestration design in a cloud automation process can include sequential and declarative lifecycle actions accessed from a service registry, but resource changes or other variables allow for event-based architecture to configure a runtime that is not accounted for in the solution, such as in circumstances where an expected, or designed, lifecycle action is unavailable from the service registry. Examples of unavailable lifecycle actions include lifecycle actions missing from the service registry and lifecycle actions that exceed or fall below a predetermined amount of time or other threshold resource, i.e., cost, in order to perform as set forth in the orchestration design.

In one example, accessing lifecycle actions of an orchestration from a service registry 202 includes deterministically implementing lifecycle actions. Deterministically implementing lifecycle actions include implementing a predetermined or designed order of execution from input to outcome. Examples of deterministic processing languages include Topology and Orchestration Specification for Cloud Applications (TOSCA) to describe a topology of cloud based web services, Business Process Execution Language (BPEL) to specify actions within business processes with web services, and others. Deterministic program constructs in orchestrations can include scripts and flows. A set of flows, recipes, or scripts that correspond to particular lifecycle actions may be performed to orchestrate corresponding cloud resources for purposes of managing the lifecycle of a given cloud capability. The actions are workflows and calls to resources offering interfaces from the service registry. Orchestration designers or administrators can compose orchestrations with tools such as an integrated development environment available under the trade designation Operations Orchestration from the present assignee.

Non-deterministically injecting lifecycle actions into the orchestration 206 includes event driven processing in which the steps in the orchestration are dynamic and have a varying outcome. In one example, more than one outcome is possible, and the lifecycle action is not predetermined in the orchestration. Examples of non-deterministic programming constructs include heuristics and anonymous functions, and reflection, which provides the ability to examine the orchestration and modify runtime behaviors. Orchestrations can include reflection to define lifecycle actions not exposed at design time.

Method 200 provides for orchestrations to combine deterministic and non-deterministic programming constructs during runtime for execution in the cloud environment 204. In one example, method 200 can be implemented as a computer readable medium storing computer readable instructions for controlling a computer system. Method 200 can be implemented as a cloud service automation and management tool or service or as an add-on to an existing cloud service automation and management tool or service. Additionally, features of the method 200 can be implemented in an integrated development environment for composing orchestrations having deterministic and non-deterministic programming constructs to be operated with cloud service automation and management tools or services.

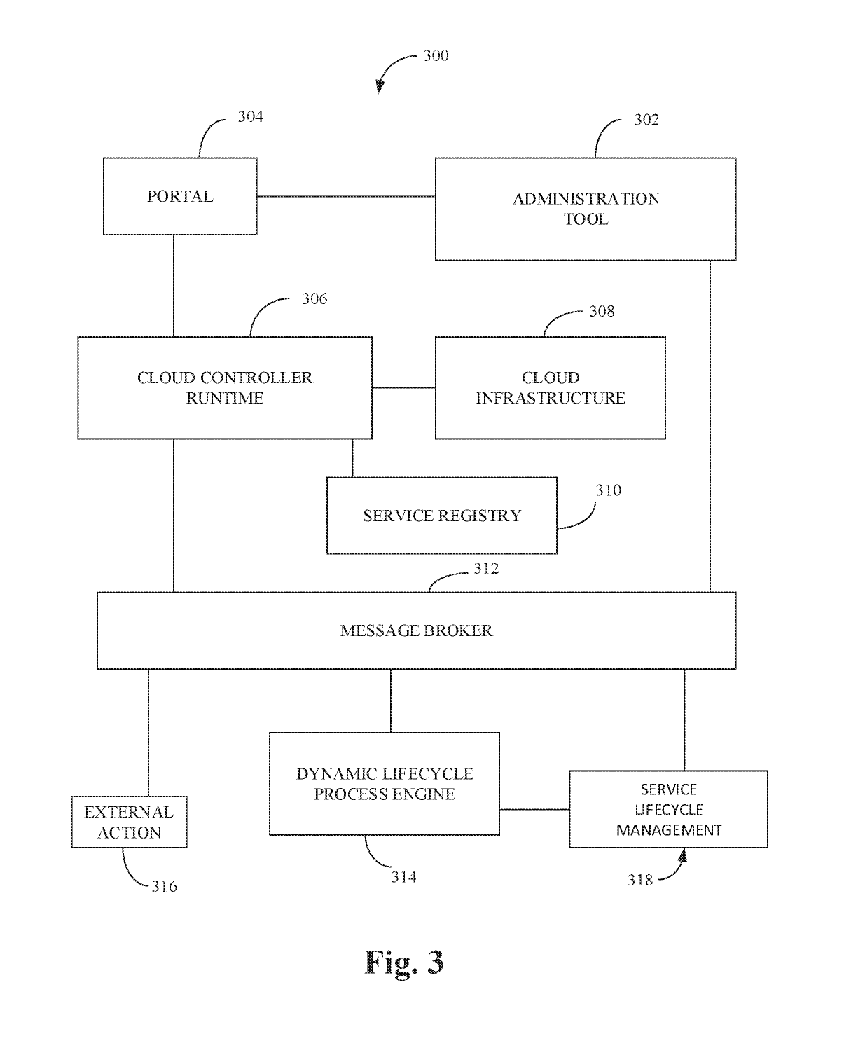

FIG. 3 illustrates an example system 300 for implementing the example method 200 (illustrated in FIG. 2) for execution in a cloud environment, such as cloud environment 100 (illustrated in FIG. 1). In one example, system 300 can be implemented as a set of modules and nodes in a computer network. An orchestration, such as an orchestration template, or service design, with eventing support or non-deterministic constructs can be provided to an administration tool 302. Eventing can include a general pattern of asynchronous event-based messages or various message delivery mechanisms and services. The orchestration template can include structured plans for instantiating and configuring cloud capabilities. The administration tool 302 can include a dashboard and a cloud controller. The administration tool 302 can also provide messaging features, such as an interface with the messaging for staging areas or distribution mechanisms such as topics or queues created with the orchestration template and to configure subscribers. The administration tool 302, in one example, exposes the orchestration template to a portal 304. In one example, the portal 304 asynchronously interacts with the orchestration,

The orchestration is executed in a cloud controller runtime 306 and realized in a cloud infrastructure 308. The portal 304 places an order for cloud services based on the orchestration to the cloud controller runtime 306. The cloud controller runtime 306 includes libraries for executing the lifecycle actions of the orchestration and includes features to execute the sequential and declarative lifecycle actions as well as an eventing action, including the non-deterministically injected lifecycle actions. The cloud infrastructure 308 includes the target environment where the orchestration template is realized, and includes hardware and services of, for example, cloud environment 100 (illustrated in FIG. 1). Examples of hardware and services include virtual machines, physical servers, network components, load balancers, block storage, disaster recovery services, backup services, firewalls, and the like.

The cloud controller runtime 306 accesses lifecycle actions of an orchestration from service registry 310. Service registry includes a repository of pre-existing service application program interface (API) definitions of resource offerings and cloud capabilities. Cloud controller runtime 306 accesses the service registry 310 to dynamically discover and invoke API endpoints to instantiate and configure resources as defined by the sequential and declarative lifecycle actions of the orchestration. In one example, the cloud controller runtime 306 searches the service registry 310 for the lifecycle action. If the resources are available in the service registry 310 as declared in the orchestration, the cloud controller runtime 306 executes the lifecycle action.

If, however, the resource is not available from the service registry 310, the cloud controller runtime 306 can non-deterministically create and inject the lifecycle action implementation into the orchestration. In one example, the cloud controller runtime 306 accesses a message broker 312 over a message bus in the network to inject the missing action. The message broker 312 can include, for example, an enterprise-class open-source or commercial message broker such as a Java Message Service message broker, Advanced Message Queuing Protocol message broker, or other message broker. The message broker 312 interacts with the cloud controller runtime 306 and the administration tool 302, which can configure topics and queues for injecting lifecycle actions. Additionally, the message broker 312 interacts with a dynamic lifecycle process engine 314 to non-deterministically create and inject the lifecycle action. In some example, the message broker 312 can also be applied to trigger synchronous or asynchronous external actions 316 for delivery via messaging. Further, the message broker 312 can interact with service lifecycle management module 318 to implement the lifecycle actions injected with the dynamic lifecycle process engine 314.

The dynamic lifecycle process engine 314, in one example, can search a persistent store of lifecycle actions and compare the stored actions to the lifecycle actions being executed in the orchestration to decipher missing lifecycle actions or lifecycle actions not available to be accessed in the service registry. In one example, the dynamic lifecycle process engine 314 includes reflection to define lifecycle actions not exposed or available in the service registry 310.

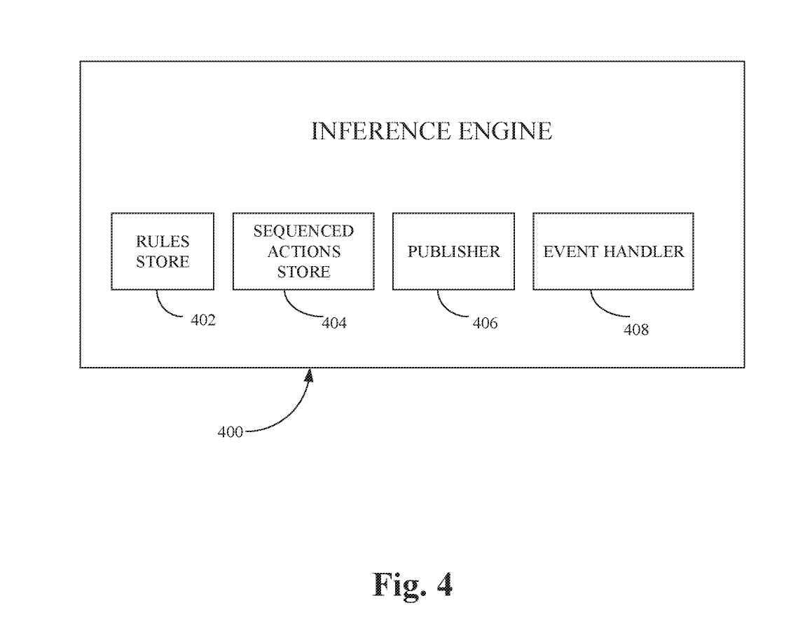

FIG. 4 illustrates an example inference engine 400 that can be included in dynamic lifecycle process engine 314 of system 300 (of FIG. 3). Inference engine 400, in one example, can include an artificial intelligence tool or expert system having a knowledge base of business rules and data regarding lifecycle actions in a data store. The inference engine 400 can apply the logical rules to the data in the knowledge base and deduce new knowledge data via processing. In one example, inference engine 400 includes forward chaining processing, which begins with data and asserts new data. Inference engine 400 can also include backward chaining processing, which begins with goals or expected outcomes and then determines data to be asserted to achieve the outcome. One example can use anonymous functions, or lambda abstractions, which include functions not bound to an identifier. Anonymous functions can be arguments passed to higher order functions or used to construct the result of higher order functions that return a function. In one example, support for anonymous functions is available in the C-sharp (C#) programming language as a lambda expression can take part in type inference and be used as a method argument. In the Java programming language, anonymous functions are also known as lambda expressions.

The inference engine 400 can receive input data from the orchestration, input data based on reflection of the service design model, input data based on relevant lifecycle services and service levels, cloud capabilities, and capacities available within a given target infrastructure environment, and input data based on lifecycle actions already comprehended by the deterministically specified lifecycle actions that are submitted by the cloud controller to determine what, if any, additional lifecycle actions are to be performed. The inference engine 400 can also determine at runtime the appropriate sequence these lifecycle action steps are to be executed in to address prerequisites or dependencies in the execution order. The inference engine 400 executes the appropriate rules in a dynamically sequenced order, which in turn provides lifecycle action events to the message broker 312 of system 300 (of FIG. 3) for processing.

In the illustrated example, Inference engine 400 includes a rules store 402, sequenced actions store 404, publisher 406, and event handler 408. In one example, inference engine 400 can be implemented as a set of one or more modules or nodes in the computer network.

Inference engine 400 can provide a business rules management system that provides processing to register, define, classify, and manage rules, verify the consistency of rule definitions, define the relationship between rules, and relate some of the rules to IT applications that are affected or applied to enforce one or more rules. Rules store 402 can include memory to store rules for the cloud environment. For example, a rule can include a definition for sets of customers eligible for free shipping (e.g., first criteria if quantity of products purchased is greater than x, second criteria if quantity of products is greater than y). Examples of other rules include rules for providing backup depending on criteria, providing services such as backup if no service is specified in the orchestration, providing data classifications for determining which sets of data are to be encrypted or saved to third party persistent storage sites, and the like.

Sequenced actions store 404 can include actions to be performed that are not included in the orchestration or service design. For example, an action from sequenced actions store 404 can include enlarging system storage size to accommodate backups specified in the service design. In one example, sequenced actions store 404 includes actions that account for possible variability in resources.

Publisher 406 publishes the injected lifecycle actions to a message bus, or the like. Event handler 408 can create a listener on the message broker 312 (of FIG. 3) to react to a particular message event. For example, the lifecycle action provided with the dynamic lifecycle process engine 314 (of FIG. 3) can be published with a handler to perform the lifecycle action, such as with the creation of a queue or topic with a corresponding listener that can react to the message on topic or queue.

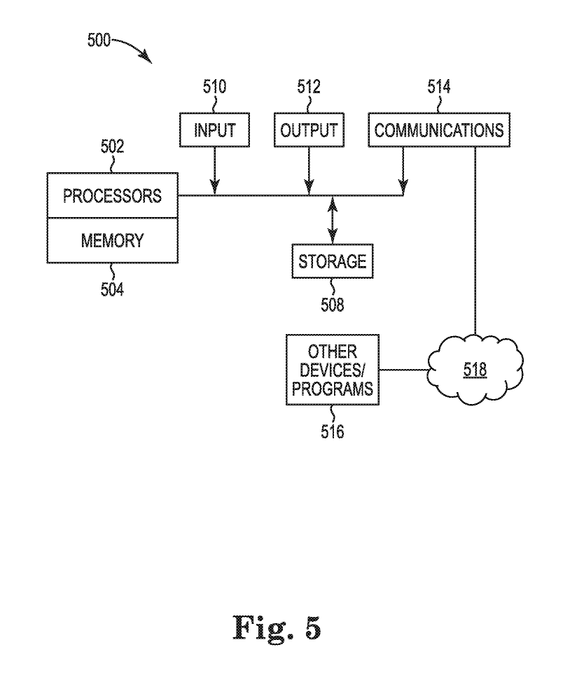

FIG. 5 illustrates an example computer system that can be employed in an operating environment and used to host or run a computer application implementing an example method 200 (of FIG. 2) as included on a computer readable storage medium storing computer executable instructions for controlling the computer system, such as a computing device, to perform a process. In one example, the computer system of FIG. 5 can be used to implement the modules and its associated tools set forth in system 300 (of FIG. 3).

The exemplary computer system of FIG. 5 includes a computing device, such as computing device 500. Computing device 500 typically includes a processor 502 and memory 504. The processors 502 may include two or more processing cores on a chip or two or more processor chips. In some examples, the computing device 500 can also include an additional processing or specialized processors (not shown), such as a graphics processor for general-purpose computing on graphics processor units, to perform processing functions offloaded from the processor 502. Memory 504 may be arranged in a hierarchy and may include, in some examples, more than one level of cache. Memory 504 may be volatile (such as random access memory (RAM)), non-volatile (such as read only memory (ROM), flash memory, etc.), or some combination of the two. The computing device 500 may take one of several forms. Such forms include a tablet, a personal computer, a workstation, a server, a handheld device, a consumer electronic device (such as a video game console or a digital video recorder), or other, and can be a stand-alone device or configured as part of a computer network, computer cluster, cloud services infrastructure, or other.

Computing device 500 may also include additional storage 508. Storage 508 may be removable and/or non-removable and can include magnetic or optical disks or solid-state memory, or flash storage devices. Computer storage media includes volatile and nonvolatile, removable and non-removable media implemented in any suitable method or technology for storage of information such as computer readable instructions, data structures, program modules or other data. A propagating signal by itself does not qualify as storage media.

Computing device 500 often includes input and/or output connections, such as USB connections, display ports, proprietary connections, and others to connect to various devices to receive and/or provide inputs and outputs. Input devices 510 may include devices such as keyboard, pointing device (e.g., mouse), pen, voice input device, touch input device, or other. Output devices 512 may include devices such as a display, speakers, printer, or the like. Computing device 500 often includes one or more communication connections 514 that allow computing device 500 to communicate with other computers/applications 516. Example communication connections can include, but are not limited to, an Ethernet interface, a wireless interface, a bus interface, a storage area network interface, a proprietary interface. The communication connections can be used to couple the computing device 500 to a computer network 518, which is a collection of computing devices and possibly other devices interconnected by communications channels that facilitate communications and allows sharing of resources and information among interconnected devices. Examples of computer networks include a local area network, a wide area network, the Internet, or other network.

Computing device 500 can be configured to run an operating system software program and a computer application, which make up a system platform. A computer application configured to execute on the computing device 500 is typically provided as a set of instructions written in a programming language. A computer application configured to execute on the computing device 500 includes at least one computing process (or computing task), which is an executing program. Each computing process provides the computing resources to execute the program.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A method of managing a cloud environment, comprising:
accessing Recycle actions of an orchestration from a service registry;
executing the orchestration in the cloud environment; and
non-deterministically injecting into the orchestration lifecycle actions that are not available in the service registry.

2. The method of claim 1 wherein the cloud environment includes a hybrid cloud.

3. The method of claim 1 wherein executing the orchestration in the cloud environment includes executing the orchestration in a cloud controller runtime.

4. The method of claim 3 wherein the executed orchestration is realized in a cloud infrastructure.

5. The method of claim 3 wherein the service registry includes resource offerings and cloud capabilities.

6. The method of claim 5 wherein accessing the lifecycle actions includes searching the resource offerings and cloud capabilities.

7. The method of claim 3 wherein executing the orchestration includes executing the orchestration from resources in the service registry.

8. The method of claim 1 wherein non-deterministically injecting includes accessing a dynamic lifecycle process engine.

9. The method of claim 8 wherein non-deterministically injecting includes accessing an inference engine.

10. The method of claim 8 wherein the accessing includes accessing the dynamic lifecycle process engine via a message broker,

11. The method of claim 8 wherein non-deterministically injecting includes reflection to define lifecycle action implementations.

12. A non-transitory computer readable medium for storing computer executable instructions for controlling a computing device to perform a method of managing a cloud environment, comprising:
accessing lifecycle actions of an orchestration from a service registry;
executing the orchestration in the cloud environment; and
non-deterministically creating and injecting into the orchestration lifecycle actions that are not available in the service registry.

13. The computer readable medium of claim 12 wherein lifecycle actions accessed from the service registry include declarative and sequential actions.

14. A system for of managing a cloud environment, comprising:
a processor and memory configured to,
access lifecycle actions of an orchestration from a service registry;
execute the orchestration in the cloud environment; and
non-deterministically create and inject into the orchestration lifecycle actions that are not available in the service registry.

15. The system of claim 14 wherein the non-deterministically injected lifecycle actions are not predetermined in the orchestration.
